(19) United States
(12) Patent Application Publication
(10) Pub. No.: US 2002/0077433 A1
(43) Pub. Date: Jun. 20, 2002

(54) Catalyst system for the polymerization of dienes

(76) Inventors: Sigurd Becke, Rosrath (DE); Uwe Denninger, Bergisch Gladbach (DE); Steffen Kahlert, Koln (DE); Werner Obrecht, Moers (DE); Claudia Schmid, Leichlingen (DE); Heike Windisch, Leverkusen (DE)

Correspondence Address: BAYER CORPORATION, PATENT DEPARTMENT, 100 BAYER ROAD, PITTSBURGH, PA, 15205, US

(21) Appl. No.: 09/949,527

(22) Filed: Sep. 7, 2001

(30) Foreign Application Priority Data
Sep. 11, 2000 (DE) 10044981.6

(51) Int. Cl. C08F 4/44

(52) U.S. Cl. 526/160; 526/943; 526/346; 502/152

(57) ABSTRACT

The present invention relates to the use of new catalysts containing a metal-free cyclopentadienide compound and a transition-metal compound for the polymerization of unsaturated compounds, in particular of conjugated dienes.

In this connection the use of methylaluminoxane (MAO) or of boron-containing compounds as co-catalyst can be dispensed with and nevertheless a high catalyst activity can be obtained.

### FIELD OF THE INVENTION

The present invention relates to the use of new catalysts containing a metal-free cyclopentadienide compound and a transition-metal compound for the polymerization of unsaturated compounds, in particular of conjugated dienes.

In this connection, the use of methylaluminoxane (MAO) or of boron-containing compounds as co-catalyst can be dispensed with and nevertheless a high catalyst activity can be obtained.

### BACKGROUND OF THE INVENTION

Metal-containing cyclopentadienide compounds are known. For example, the compound cyclopentadienyllithium is formed by conversion of cyclopentadiene with butyllithium accompanied by formation of the cyclopentadienide anion (Cp anion). Known from magnesium is magnesocene, whereby two Cp anions are bound to the magnesium. Cp anions form stable complexes with transition metals. In the case of ferrocene, there are two Cp anions, which surround the metal atom in such a way that a so-called sandwich compound (metallocene) arises.

The bond between the Cp anion and the transition-metal anion is particularly stable in the case of the metallocenes, since co-ordination of the Cp anion is effected via the π-electrons of the C₅H₅ ring.

The polymerization of unsaturated organic compounds, in particular conjugated dienes, in the presence of catalysts based on rare-earth metals is known (see, e.g., DE 28 33 721, U.S. Pat. No. 4,429,089, EP-A1-0 076 535, EP-A1-0 092 270, EP-A1-0 092 271, EP-A1-0 207 558, WO-93/05083 A1, U.S. Pat. No. 5,627,119, EP-A1-0 667 357, U.S. Pat. No. 3,478,901, EP-A1-0 637 589). Compounds of the rare-earth metals do not exhibit polymerization activity on their own. In combination with co-catalysts, e.g. MAO, active polymerization catalysts arise (Macromol. Symp. Vol. 97, July 1995 and R. Taube, Macomol. Symp. Vol. 89, January 1995, 393-409). In this context, the Ziegler-Nafta catalysts based on the rare-earth metals have proven their worth. For instance, in EP-A1-0 011 184, a catalyst system based on the rare-earth metals, in particular based on neodymium compounds, is presented which is very well suited for the polymerization of conjugated dienes, in particular butadiene. In the case of the polymerization of butadiene, for example, these catalysts produce a polybutadiene, in very good yields and with high selectivity, which is distinguished in particular by a high proportion of cis-1, 4 units. But a disadvantage with the use of these catalysts for the polymerization of conjugated dienes is their low proportion of laterally bonded vinyl groups (1,2 units) in the polymer, which in the polymer frequently amounts to less than 1%.

In WO-96/31544 A1, catalysts based on structurally defined allyl complexes of the rare-earth metals and alumoxane were described, with which diene rubbers having a high proportion of 1,4-cis double bonds and a content of lateral vinyl groups amounting to more than 1% are obtained.

Moreover, in WO-99/20670 A1, for example, a catalyst system based on compounds of the rare-earth metals, cyclopentadiene and alumoxane were described, with which polydienes containing a high cis proportion with a variable proportion of lateral vinyl groups are formed. WO-00/04066 A1 and DE-A1-199 39 842 describe the use of the aforementioned catalyst systems with alumoxane activation for the copolymerization of dienes with 1-olefins such as styrene-butadiene copolymers.

In addition to the catalysts based on compounds of the rare-earth metals, further systems are also known with which, for example, polybutadienes are obtained which with a high proportion of 1,4-cis double bonds have a content of lateral vinyl groups amounting to 10-20%. As examples of these, mention may be made of catalysts based on monocyclopentadienyl compounds of vanadium with co-catalysts based on alumoxane or on perfluorinated borates (e.g. G. Ricci et al., Polymer 3772, 1996, 363-365, EP-A1-0 778 291, EP-A1-0 841 375, EP-A1-0 919 574) as well as catalysts based on monocyclopentadienyl compounds of titanium with co-catalysts based on alumoxane or on perfluorinated borates (G. Ricci et al., J. Organomet. Chem., 451, 1993, 67-72; G. Ricci et al., Mocromol. Symp. 89,1995, 383-392; S. Ikai et al., J. Mol. Catal. A: Chem., 140(2),1999, 115-119; JP-A-81/13610, JP-A-09/077818, JP 9286810, DE-A1-19835785).

However, the catalyst systems based on compounds of the rare-earth metals, monocyclopentadienyl compounds of titanium or also of vanadium and alumoxane have considerable disadvantages at the present time. For instance, alumoxanes, in particular MAO, cannot be produced with high reproducibility either in situ or in a preforming process. MAO is a mixture of various species containing aluminum alkyl which are present with one another in equilibrium, this being at the cost of reproducibility in the course of polymerization. In addition, MAO is not stable in storage and changes its composition in the event of thermal loading. A further serious disadvantage is the high excess of MAO, which is required in connection with the activation of compounds of the rare-earth metals. But the high ratio of MAO to rare-earth metal is an absolute prerequisite in order to obtain high catalyst activities. This results, however, in a major disadvantage of the process, since the aluminum compounds have to be separated from the polymers in the course of processing. In addition, MAO is a cost-determining factor with the use of MAO-containing catalyst systems, which means that excesses of MAO are uneconomical.

In EP-A1-0 677 357, partially fluorinated or perfluorinated organoboron Lewis acids such as tris(pentafluorophenyl)borane are described as a co-catalyst for compounds of the rare-earth metals in combination with aluminum organyls. In DE-A1-197 20 171, cationic allyl complexes, which display high activities as single-site catalysts in the polymerization of butadiene, are obtained by conversion of allyl complexes of the compounds of the rare-earth metals with perfluorinated boranes or borates. A disadvantage is that with these catalysts the highest activities are obtained in the polar solvent such as methylene chloride, whereas for technical applications non-polar solvents such as hexane are preferred for ecological and economic reasons.

The polymerization properties of the co-catalysts based on partially fluorinated or perfluorinated boranes or borates has been widely investigated in the case of the metallocene catalysts for the polymerization of olefins. With these catalyst systems, the polymerization activity of catalysts based on tris(pentafluorophenyl)borane is inadequate. In EP-A1-277 003 and EP-A1-277 004 ionic catalyst systems are described which are produced by reaction of metallocenes with ionizing reagents. By way of ionizing reagents, perfluorinated tetra-aromatic borate compounds, in particular tetrakis(pentafluorophenyl)borate compounds are preferably employed (EP-A1-0 468 537, EP-A1-0 561 479). In EP-A1-0 561 479, a compound of the general formula (I) is described

[(L′−H⁺]_{d}(M′)^{m+}Q₁Q₂ . . . Qₙ]^{d-} (I)

in which M is a metal or metalloid of Groups V-B to V-A of the Periodic Table of the Elements. A disadvantage here is that the bonds between M and the residues Q1-Q4 is polarized.

This leads to a weakening of the bond, which can lead to a cleavage of groups Q₁-Q₄ which is also described in EP-A1-0 277 004.

Compounds of the type BR₄⁻ such as are described in EP-A1-0 561 479 can dissociate upon contact with metallocene dialkyls, accompanied by cleavage of an alkyl residue, which is to be regarded as a disadvantage, since the co-catalyst is thereby destroyed.

### SUMMARY OF THE INVENTION

An object of the present invention was to find a co-catalytically active, thermodynamically stable compound for the polymerization of unsaturated compounds with catalysts based on compounds of the rare-earth metals, with which the disadvantages of the state of the art are entirely or partially avoided. A further object was the provision of a catalyst system for the polymerization of dienes and copolymerization of dienes with 1-olefins having sufficient polymerization activities. In particular, the object was to find a catalyst system suitable for the production of BR and SBR.

It has now been found that cyclopentadienide compounds with bulky substituents are especially suitable for this object.

### DETAILED DESCRIPTION OF THE INVENTION

The present invention relates to a process for the polymerization of dienes, characterized in that polymerization takes place in the presence of a metal-free and metalloid-free cyclopentadienide compound of the general formula (II)

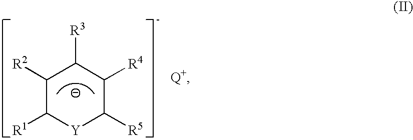

wherein

Q⁺ signifies a Lewis-acid cation according to the Lewis acid/base theory (as described, for example, in J. Huheey, Anorganische Chemie, Walter de Gruyter, Berlin, N.Y., 1988, p 315f) and preferably represents carbonium, oxonium or/and sulfonium cations, in particular the triphenylmethyl cation, or

Q⁺ signifies a Brønstedt-acid cation according to the Brønstedt acid/base theory (as described, for example, in J. Huheey, Anorganische Chemie, Walter de Gruyter, Berlin, N.Y., 1988, p 309f) and preferably represents trialkylammonium, dialkylarylammonium or/and alkyldiarylammonium, in particular N,N-dimethylanilinium

Y represents a (CR₂⁶)ₘ group with m=0 to 4, whereby the residues R⁶ may be the same or different, whereby if m=0, the ring may be closed or open, with the proviso that if the ring is open, the free valences on the terminal C atoms are saturated by residues R which have the same significance as R¹-R⁶,

R¹-R⁶ represent identical or different substituents selected from the group consisting of hydrogen, phenyl, aryl, C₁-C₂₀ alkyl, C₁-C₁₀ haloalkane, C₆-C₁₀ haloaryl, C₁- C₁₀ alkoxy, C₆-C₂₀ aryl, C₆-C₁₀ aryloxy, C₂-C₁₀ alkenyl, C₇-C₄₀ arylalkenyl, C₂-C₁₀ alkynyl, silyl optionally substituted by C₁- C₁₀ hydrocarbon residues, amine substituted C₁- C₂₀ hydrocarbon residues, with the proviso that at least one substituent, preferably at least two substituents, and more preferably, at least three substituents, are bulky.

Conjugated dienes of the formula CH₂═CR^{a}CR^{b}═CH—R^{c} are preferably polymerized in which R^{a}, R^{b} and R^{c} are the same or different and signify a hydrogen atom, a halogen atom, an alkoxy, hydroxy, alkylhydroxy, aldehyde, carboxylic-acid or carboxylic-ester group or a saturated or unsaturated hydrocarbon residue with 1 to 20 C atoms, in particular 1-10 C atoms, which may be substituted by an alkoxy, hydroxy, alkylhydroxy, aldehyde, carboxylic-acid or carboxylic-ester group, or R^{a}, R^{b} and R^{c} form one or more rings with the atoms combining them. Examples of such conjugated dienes are 1,3-butadiene, isoprene, 2-phenyl-1,3-butadiene, 1,3-pentadiene, 2-methyl-1,3-pentadiene, 4-methyl-1,3-pentadiene and/or 2,4-hexadiene. Moreover, in the course of polymerization of the conjugated dienes, optionally one or more 1-olefins may be added, such as, for example, ethylene, propene, 1-butene, 1-hexene, 1-octene, styrene, methylstyrene. Moreover, the polymerization can of course also be carried out in the presence of further compounds which, for example, may serve to regulate the molecular weight, such as, for example, hydrogen or 1,2-butadiene.

In particular, the following starting materials are polymerized:

1,3-butadiene or isoprene are homopolymerized.

1,3-butadiene or isoprene are copolymerized.

1,3-butadiene is copolymerized with one or more C₃-C₂₀-1-olefins, preferably styrene.

Isoprene is copolymerized with one or more C₃-C₂₀-1-olefins, preferably styrene.

1,3-butadiene is copolymerized with isoprene and one or more C₃-C₂₀-1-olefins, preferably styrene.

The elements boron and aluminum are designated as metalloids.

Bulky substituents, in the sense of the invention, are substituents that render difficult the formation of a covalent bond between Q⁺ and the cyclopentadienide anion.

Examples of these are branched alkyl groups, monosubstituted or polysubstituted silyl groups, monosubstituted or polysubstituted amino groups, monosubstituted or polysubstituted phosphino groups aromatic compounds, optionally substituted aromatic compounds, preferably C₁-C₁₀ haloalkane, C₆-C₂₀ haloaryl, C₆-C₂₀ aryl, C₆-C₁₀ alkoxyaryl, more preferably C₁- C₁₀ fluoroalkane, C₆-C₂₀ chloroaryl, C₁-C₁₀ chloroalkane, C₆-C₂₀ fluoroaryl, C₆-C₂₀ aryl, C₆-C₁₀ alkoxyaryl, most preferably C₁-C₁₀ fluoroalkane, C₆-C₂₀ fluoroaryl, C₆-C₂₀ aryl, C₆-C₁₀ alkoxyaryl.

Preferred compounds of the formula 11 are prepared, whereby at least one R from R¹-R⁶ represents a halogen-containing, more preferably chlorine-containing and/or fluorine-containing, aromatic compound of the formula III

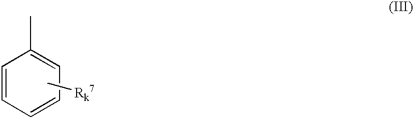

wherein

k represents an integer in the range from 1 to 5 and

R⁷ is selected from the group consisting of C₁-C₂₀ alkyl, C₁ - C₂₀ alkoxy, hydrogen, halogen, C₁-C₂₅ haloalkane, with the proviso that at least one R⁷ represents halogen or C₁-C₂₅ haloalkane, fluorine and C₁-C₂₅ fluoroalkanes being more preferred.

Examples of substituents of the formula III are 4-fluorophenyl, 4-chlorophenyl, 3-fluorophenyl, 3-chlorophenyl, 2-fluorophenyl, 2-chlorophenyl, 2,6-difluorophenyl, 2,6-dichlorophenyl, 2,4-difluorophenyl, 2,4-dichlorophenyl, 2,3-difluorophenyl, 2,3-dichlorophenyl, 2,5-difluorophenyl, 2,5-dichlorophenyl, 3,4-difluorophenyl, 3,4-dichlorophenyl, 3,5-difluorophenyl, 3,5-dichlorophenyl, 2,4,6-trifluorophenyl, 3,4,5-trifluorophenyl, 2,3,4-trifluorophenyl, 2,3,5-trifluorophenyl, 2,3,6-trifluorophenyl, 2,3,4,5-tetrafluorophenyl, 2,3,5,6-tetrafluorophenyl, 4,5,6-trifluorophenyl, pentafluorophenyl, 4-(trifluoromethyl)phenyl, 2,6-bis(trifluoromethyl)phenyl, 3,5-bis(trifluoromethyl)phenyl, 3,4,5-tris(trifluoromethyl)phenyl, 2,4,4-tris(trifluoromethyl)phenyl, particularly preferred are 4-fluorophenyl, 2,6-difluorophenyl, 2,4-difluorophenyl, 2,4,6-trifluorophenyl, pentafluorophenyl, 3,5-bis(trifluoromethyl)phenyl and compounds corresponding to the compounds just named, in which one or more fluorine atoms have been replaced by chlorine atoms, the further enumeration of which, however, would contribute nothing more to the understanding of the application.

The residues R¹-R⁶ may each form, together with the atoms combining them, one or more aliphatic or aromatic ring systems which may contain one or more heteroatoms selected from the group N, P, Si and exhibit 5-10 carbon atoms.

In exemplary manner, compounds of the formulae IIa and IIb may be mentioned:

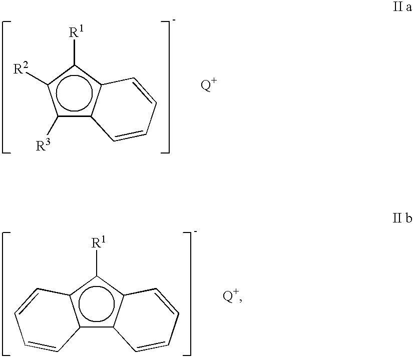

wherein

Q⁺ signifies a Lewis-acid cation according to the Lewis acid/base theory (see above), preferably carbonium, oxonium or/and sulfonium cations, in particular the triphenylmethyl cation, or

Q⁺ signifies a Brønstedt-acid cation according to the Brønstedt acid/base theory (see above), preferably trialkylammonium, dialkylarylammonium or/and alkyldiarylammonium, in particular N,N-dimethylanilinium, and

R¹-R³ have the significance stated in connection with (II).

It is trivial that the ring systems may, in turn, be substituted.

Suitable as substituents are, for example, the examples for R¹-R⁶.

More preferred cyclopentadienide compounds of the general formula (II) are compounds of the formula (IIc)

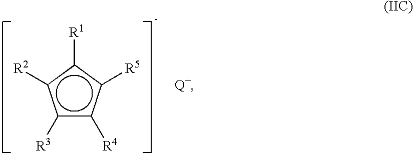

wherein

R¹-R⁵ and Q⁺ have the significance already stated.

In the production of the cyclopentadienes, indenes or fluorenes that are aryl-substituted in the 1-position, the starting-point is expediently the corresponding cyclopentadienones, indenones or fluorenones, and the latter are converted into the cyclopentadienes, indenes or fluorenes in accordance with R. H. Lowack and K. P. C. Vollhardt (J. organomet. Chem., 1994, 476, 25-329).

To the extent that they are not commercially available, tetraaryl-substituted cyclopentadienones can be produced in accordance with W. Dilthey and F. Quint (J. prakt. Chem. 1930, 128, 139) from benzil derivatives and 1,3-diarylacetones, in accordance with M. Miura, S. Pivsa-Art, G. Dyker, J. Heiermann, T. Satoh, M. Nomura (Cem. Comm. 1998, 1889) from zirconocene dichloride and aryl bromides by a Heck reaction or in accordance with J. M. Birchall, F. L. Bowden, R. N. Hazeldine and A. b. P. Lever (J. Cem. Soc. (A) 1967, 747) by conversion of corresponding tolanes with dicobalt octacarbonyl.

From these cyclopentadienones the cyclopentadienes that are aryl-substituted in the 1-position can be obtained by reaction with aryllithium or arylmagnesium halides at low temperatures and subsequent reduction with zinc/acetic acid, lithium aluminum hydride or other suitable reducing agents.

Production of the metal-free cyclopentadienide compound is preferably effected by exchange of a proton from a cyclopentadiene, in which the substituents R¹-R⁶ have the meanings stated above, for a metal or an organometallic compound, preferably an alkali metal or an organometallic compound pertaining to Group 1, 12 or 14.

This is effected by conversion with a metal alkyl compound or with a metal, preferably an alkali-metal alkyl compound or an alkali metal or an organometallic compound pertaining to Group 12 or 14. n-butyllithium, tert.-butyllithium, sodium and potassium have proven to be particularly suitable.

Subsequent to this, the reaction with a halide of the corresponding metal-free and metalloid-free cation takes place, in order to obtain the compounds (II).

The reaction with dimethylanilinium hydrochloride or tritylium chloride has proved to be particularly advantageous. Suitable solvents for the formation of the compounds according to the present invention are aliphatic and aromatic hydrocarbons, ethers and cyclic ethers. Examples of these are pentane, hexane, heptane, octane, cyclohexane, benzene, toluene, xylene, dialkyl ether and tetrahydrofuran. Mixtures of various solvents are also suitable.

The synthesis of the compounds according to the present invention is also simple to carry out on a technical scale. By reason of their crystallizability, the substances can be produced with a high degree of purity and with good yields. With a view to purification, merely the metal halide arising in the course of the reaction has to be removed, which is easily possible by reason of its poor solubility in hydrocarbons.

It has been found that the metal-free cyclopentadienide compounds according to the present invention are particularly well suited for the production of a catalyst system for the polymerization of dienes.

Therefore compositions containing:

a) at least one cyclopentadienide compound according to the present invention

b) at least one transition-metal compound as well as, optionally in addition, an organoaluminum compound are a further subject of the invention.

Aluminum compounds, which are optionally present are, in particular, trialkylaluminum compounds, dialkylaluminum hydrides, dialkylaluminum chlorides, and alkylaluminum dichlorides. Preferred embodiments of the aluminum compounds are trimethylaluminum, triethylaluminum, triisobutylaluminum, triisooctylaluminum, diisobutylaluminum hydride, diethylaluminum chloride.

Suitable as transition-metal compounds are:

compounds of the rare-earth metals

monocyclopentadienyl compounds of titanium

monocyclopentadienyl compounds of vanadium

or mixtures of these.

In this connection, compounds of the rare-earth metals are preferred.

The following compounds of the rare-earth metals, those enter into consideration which are selected from

an alcoholate of the rare-earth metals,

a carboxylate of the rare-earth metals,

a complex compound of the rare-earth metals with diketones and/or

an addition compound of the halides of the rare-earth metals with an oxygen or nitrogen donor compound.

The aforementioned compounds of the rare-earth metals are described in greater detail in EP-A1-0 011 184.

The compounds of the rare-earth metals are based, in particular, on the elements with atomic numbers 21, 39 and 57 to 71. In preferred manner, lanthanum, praseodymium or neodymium are employed by way f rare-earth metals, or a mixture of elements of the rare-earth metals is employed that contains at least one of the elements lanthanum, praseodymium or neodymium in a proportion amounting to at least 10%. Preferably, lanthanum or neodymium are employed by way of rare-earth metals, which may, in turn be blended with other rare-earth metals. The proportion of lanthanum and/or neodymium in such a mixture amounts in preferred manner to at least 30 wt. %.

By way of alcoholates and carboxylates of the rare-earth metals or by way of complex compounds of the rare-earth metals with diketones, in particular those enter into consideration in which the organic group contained in the compounds contains, in particular, straight-chain or branched alkyl residues with 1 to 20 carbon atoms, preferably 1 to 15 carbon atoms, such as methyl, ethyl, n-propyl, n-butyl, n-pentyl, isopropyl, isobutyl, tert.-butyl, 2-ethylhexyl, neopentyl, neooctyl, neodecyl or neododecyl residues.

By way of alcoholates of the rare-earth metals, the following are named, for example: nodymium(III) n-propanolate, neodymium(III) n-butanolate, neodymium(III) n-decanolate, neodymium(III) isopropanolate, neodymium(III) 2-ethylhexanolate, praseodymium(III) n-propanolate, praseodymium(III) n-butanolate, praseodymium(III) n-decanolate, praseodymium(III) isopropanolate, praseodymium(III) 2-ethylhexanolate, lanthanum(III) n-propanolate, lanthanum(III) n-butanolate, lanthanum(III) n-decanolate, lanthanum(III) isopropanolate, lanthanum(III) 2-ethylhexanolate, preferably neodymium(III) n-butanolate, neodymium(III) n-decanolate, neodymium(III) 2-ethylhexanolate.

Suitable as carboxylates of the rare-earth metals are: lanthanum(III) propionate, lanthanum(III) diethyl acetate, lanthanum(III) 2-ethylhexanoate, lanthanum(III) stearate, lanthanum(III) benzoate, lanthanum(III) cyclohexanecarboxylate, lanthanum(III) oleate, lanthanum(III) versatate, lanthanum(III) naphthenate, praseodymium(III) propionate, praseodymium(III) diethyl acetate, praseodymium(III) 2-ethylhexanoate, praseodymium(III) stearate, praseodymium(III) benzoate, praseodymium(III) cyclohexanecarboxylate, praseodymium(III) oleate, praseodymium(III) versatate, praseodymium(III) naphthenate, neodymium(III) propionate, neodymium(III) diethyl acetate, neodymium(III) 2-ethylhexanoate, neodymium(III) stearate, neodymium(III) benzoate, neodymium(III) cyclohexanecarboxylate, neodymium(III) oleate, neodymium(III) versatate, neodymium(III) naphthenate, preferably neodymium(III) 2-ethylhexanoate, neodymium(III) versatate, neodymium(III) naphthenate. Neodymium versatate is more preferred.

By way of complex compounds of the rare-earth metals with diketones, mention may be made of: lanthanum(III) acetylacetonate, praseodymium(III) acetylacetonate, neodymium(III) acetylacetonate, preferably neodymium(III) acetylacetonate.

By way of addition compounds of the halides of the rare-earth metals with an oxygen or nitrogen donor compound, the following are named, for example:

lanthanum(III) chloride with tributyl phosphate, lanthanum(III) chloride with tetrahydrofuran, lanthanum(III) chloride with isopropanol, lanthanum(III) chloride with pyridine, lanthanum(III) chloride with 2-ethylhexanol, lanthanum(III) chloride with ethanol, praseodymium(III) chloride with tributyl phosphate, praseodymium(III) chloride with tetrahydrofuran, praseodymium(III) chloride with isopropanol, praseodymium(III) chloride with pyridine, praseodymium(III) chloride with 2-ethylhexanol, praseodymium(III) chloride with ethanol, neodymium(III) chloride with tributyl phosphate, neodymium(III) chloride with tetrahydrofuran, neodymium(III) chloride with isopropanol, neodymium(III) chloride with pyridine, neodymium(III) chloride with 2-ethylhexanol, neodymium(III) chloride with ethanol, lanthanum(III) bromide with tributyl phosphate, lanthanum(III) bromide with tetrahydrofuran, lanthanum(III) bromide with isopropanol, lanthanum(III) bromide with pyridine, lanthanum(III) bromide with 2-ethylhexanol, lanthanum(III) bromide with ethanol, praseodymium(III) bromide with tributyl phosphate, praseodymium(III) bromide with tetrahydrofuran, praseodymium(III) bromide with isopropanol, praseodymium(III) bromide with pyridine, praseodymium(III) bromide with 2-ethylhexanol, praseodymium(III) bromide with ethanol, neodymium(III) bromide with tributyl phosphate, neodymium(III) bromide with tetrahydrofuran, neodymium(III) bromide with isopropanol, neodymium(III) bromide with pyridine, neodymium(III) bromide with 2-ethylhexanol, neodymium(III) bromide with ethanol, preferably lanthanum(III) chloride with tributyl phosphate, lanthanum(III) chloride with pyridine, lanthanum(III) chloride with 2-ethylhexanol, praseodymium(III) chloride with tributyl phosphate, praseodymium(III) chloride with 2-ethylhexanol, neodymium(III) chloride with tributyl phosphate, neodymium(III) chloride with tetrahydrofuran, neodymium(III) chloride with 2-ethylhexanol, neodymium(III) chloride with pyridine, neodymium(III) chloride with 2-ethylhexanol, neodymium(III) chloride with ethanol.

Preferably, neodymium versatate, neodymium octanoate and/or neodymium naphthenate are employed by way of compounds of the rare-earth metals.

By way of monocyclopentadienyl compounds of titanium, those enter into consideration which are described in greater detail in, for example, JP 8113610, JP 09077818, JP 9286810 and DE 19835785.

Examples of the monocyclopentadienyl compounds of titanium are: cyclopentadienyltitanium trifluoride, cyclopentadienyltitanium trichloride, cyclopentadienyltitanium tribromide, cyclopentadienyltitanium trimethyl, cyclopentadienyltitanium triethyl, cyclopentadienyltitanium triisopropyl, cyclopentadienyltitanium triphenyl, cyclopentadienyltitanium tribenzyl, cyclopentadienyltitanium-2,4-dimethylpentadienyl, cyclopentadienyltitanium-2,4-dimethylpentadienyl triethylphosphine, cyclopentadienyltitanium-2,4-dimethylpentadienyl trimethylphosphine, pentamethylcyclopentadienyltitanium dimethyl methoxide, pentamethylcyclopentadienyltitanium dimethyl chloride, pentamethylcyclopentadienyltitanium trifluoride, pentamethylcyclopentadienyltitanium trichloride, pentamethylcyclopentadienyltitanium tribromide, pentamethyl-cyclopentadienyltitanium trimethyl, pentamethylcyclopentadienyltitanium triethyl, pentamethylcyclopentadienyltitanium triisopropyl, pentamethylcyclopentadienyl-titanium triphenyl, pentamethylcyclopentadienyltitanium tribenzyl, pentamethylcyclopentadienyltitanium-2,4-dimethylpentadienyl, pentamethylcyclopentadienyltitanium-2,4-dimethylpentadienyl triethylphosphine, pentamethylcyclopentadienyltitanium-2,4-trimethylphosphine, pentamethylcyclopentadienyltitanium dimethyl methoxide, pentamethylcyclopentadienyltitanium dimethyl chloride, pentamethylcyclopentadienyltitanium triisopropyl, pentamethylcyclopentadienyltitanium tribenzyl, pentamethylcyclopentadienyltitanium dimethyl methoxide, pentamethylcyclopentadienyltitanium dimethyl chloride, indenyltitanium trifluoride, indenyltitanium trichloride, indenyltitanium tribromide, indenyltitanium trimethyl, indenyltitanium triethyl, indenyltitanium triisopropyl, indenyltitanium triphenyl, indenyltitanium tribenzyl, indenyltitanium-2,4-dimethylpentadienyl, indenyltitanium-2,4-dimethylpentadienyl triethylphosphine, indenyltitanium-2,4-dimethylpentadienyl trimethylphosphine, tetrahydroindenyltitanium trifluoride, tetrahydroindenyltitanium trichloride, tetrahydroindenyltitanium tribromide, tetrahydroindenyltitanium trimethyl, tetrahydroindenyltitanium triethyl, tetrahydroindenyltitanium triisopropyl, tetrahydroindenyltitanium triphenyl and tetrahydroindenyltitanium tribenzyl.

By way of monocyclopentadienyl compounds of vanadium, those enter into consideration which are described in greater detail in, for example, EP 778291, EP 841375 and EP 919574.

Examples of the monocyclopentadienyl compounds of vanadium are: monosubstituted cyclopentadienylvanadium trichlorides such as methyl-cyclopentadienylvanadium trichloride, ethylcyclopentadienylvanadium trichloride, propylcyclopentadienylvanadium trichloride, isopropylcyclopentadienylvanadium trichloride, t-butylcyclopentadienylvanadium trichloride, (1,1 -dimethylpropyl)cyclopentadienylvanadium trichloride, benzylcyclopentadienylvanadium trichloride, (1,1-dimethylbenzyl)cyclopentadienylvanadium trichloride, (3-pentyl)cyclopentadienyl-vanadium trichloride, (diethylbenzyl)cyclopentadienylvanadium trichloride, and (trimethylsilylcyclopentadienyl)vanadium trichloride.

1,2-disubstituted cyclopentadienylvanadium trichlorides such as 1,2-dimethylcyclopentadienylvanadium trichloride, 1-ethyl-2-methylcyclopenta-dienylvanadium trichloride, 1-methyl-2-propylcyclopentadienylvanadium trichloride, 1-methyl-2-trimethylsilylcyclopentadienylvanadium trichloride, 1,2-bis(trimethylsilyl)-cyclopentadienylvanadium trichloride, 1-methyl-2-bis(trimethylsilyl)methyl-cyclopentadienylvanadium trichloride, 1-methyl-2-phenylcyclopentadienylvanadium trichloride, 1-methyl-2-tolylcyclopentadienylvanadium trichloride, 1-methyl-2-(2,6-dimethylphenyl)cyclopentadienylvanadium trichloride and 1-butyl-2-methylcyclopenta-dienylvanadium trichloride.

1,3-disubstituted cyclopentadienylvanadium trichlorides such as 1,3-dimethylcyclopentadienylvanadium trichloride, 1 -ethyl-3-methylcyclopenta-dienylvanadium trichloride, 1-methyl-3-propylcyclopentadienylvanadium trichloride, 1-methyl-3-trimethylsilylcyclopentadienylvanadium trichloride, 1,3-bis(trimethylsilyl)-cyclopentadienylvanadium trichloride, 1-methyl-3-bis(trimethylsilyl)methyl-cyclopentadienylvanadium trichloride, 1-methyl-3-phenylcyclopentadienylvanadium trichloride, 1-methyl-3-tolylcyclopentadienylvanadium trichloride, 1-methyl-3-(2,6-dimethylphenyl)cyclopentadienylvanadium trichloride and 1-butyl-3-methylcyclopentadienylvanadium trichloride.

1,2,3-trisubstituted cyclopentadienylvanadium trichlorides such as 1,2,3-trimethylcyclopentadienylvanadium trichloride.

1,2,4-trisubstituted cyclopentadienylvanadium trichlorides such as 1,2,4-trimethylcyclopentadienylvanadium trichloride.

Tetrasubstituted cyclopentadienylvanadium trichlorides such as 1,2,3,4-tetramethylcyclopentadienylvanadium trichloride and 1,2,3,4-tetraphenylcyclo-pentadienylvanadium trichloride.

Pentasubstituted cyclopentadienylvanadium trichlorides such as pentamethylcyclopentadienylvanadium trichloride, 1,2,3,4-tetramethyl-5-phenylcyclo-pentadienylvanadium trichloride and 1-methyl-2,3,4,5-tetraphenyl-cyclopentadienylvanadium trichloride.

Indenylvanadium trichlorides such as 2-methylindenylvanadium chloride and 2-trimethylsilylindenylvanadium chloride.

Monoalkoxides, dialkoxides and trialkoxides which are obtained by substitution of chlorine atoms in the aforementioned unsubstituted and substituted monocyclopentadienylvanadium compounds by alkoxide groups, such as cyclopentadienylvanadium tri(tert.-butoxide), cyclopentadienylvanadium triisopropoxide, cyclopentadienylvanadium dimethoxy chloride, cyclopentadienylvanadium diisopropoxy chloride, cyclopentadienylvanadium di(tert.-butoxy) chloride, cyclopentadienylvanadium diphenoxy chloride, cyclopentadienylvanadium isopropoxy dichloride, cyclopentadienylvanadium tert.-butoxy dichloride and cyclopentadienylvanadium phenoxy dichloride.

Methylated compounds which are obtained by substitution of chlorine atoms in the aforementioned unsubstituted and substituted monocyclopentadienylvanadium compounds by methyl groups, such as cyclopentadienylvanadium trimethyl, cyclopentadienylvanadium dimethyl chloride and cyclopentadienylvanadium methyl dichloride.

Compounds in which the groups on the vanadium are combined with one another by hydrocarbon or silane groups with one another, such as (tert.-butylamide)dimethyl(cyclopentadienyl)silane vanadium dichloride, (tert.-butylamide)dimethyl(trimethylcyclopentadienyl)silane vanadium dichloride and (tert.-butylamide)di-methyl(tetramethylcyclopentadienyl)silane vanadium dichloride.

Compounds in which the groups on the vanadium are combined with one another by hydrocarbon or silane groups with one another and which are obtained by substitution of one or two chlorine atoms by methyl groups, such as (tert.-butylamide)dimethyl(cyclopentadienyl)silane vanadium dimethyl, (tert.-butyl-amide)dimethyl(trimethylcyclopentadienyl)silane vanadium dimethyl, (tert.-butylamide)dimethyl(tetramethylcyclopentadienyl)silane vanadium dimethyl, (tert.-butylamide)dimethyl(cyclopentadienyl)silane vanadium methyl chloride, (tert.-butylamide)dimethyl(trimethylcyclopentadienyl)silane vanadium methyl chloride and (tert.-butylamide)dimethyl(tetramethylcyclopentadienyl)silane vanadium methyl chloride.

Unsubstituted and substituted cyclopentadienylvanadium compounds in which the groups on the vanadium are combined with one another by hydrocarbon or silane groups with one another and which are obtained by substitution of one or two chlorine atoms by monoalkoxide and dialkoxide groups.

Unsubstituted and substituted cyclopentadienylvanadium compounds in which the groups on the vanadium are combined with one another by hydrocarbon or silane groups with one another and which are obtained by substitution of one or two chlorine atoms by amide groups, such as cyclopentadienylvanadium tris(diethylamide), cyclopentadienylvanadium tris(isopropylamide), cyclopentadienylvanadium tris(octylamide), cyclopentadienylvanadium bis(diethylamide) chloride, cyclopentadienylvanadium bis(isopropylamide) chloride, cyclopentadienylvanadium bis(octylamide) chloride, cyclopentadienylvanadium diethylamide dichloride, cyclopentadienylvanadium isopropylamide dichloride, cyclopentadienylvanadium octylamide dichloride, trimethylsilylcyclopentadienylvanadium tris(diethylamide), trimethylsilylcyclopentadienylvanadium tris(isopropylamide), trimethylsilylcyclo-pentadienylvanadium tris(octylamide), trimethylsilylcyclopentadienylvanadium bis(diethylamide) chloride, trimethylsilylcyclopentadienylvanadium bis(isopropylamide) chloride, trimethylsilylcyclopentadienylvanadium bis(octylamide) chloride, trimethylsilylcyclopentadienylvanadium diethylamide dichloride, trimethylsilylcyclopentadienylvanadium isopropylamide dichloride and trimethylsilylcyclopentadienylvanadium octylamide dichloride.

Unsubstituted and substituted cyclopentadienylvanadium compounds which contain neutral ligands such as olefins, dienes, aromatic hydrocarbons, amines, amides, phosphines, ethers, ketones or esters, such as cyclopentadienylvanadium dichloride tetrahydrofuran, cyclopentadienylvanadium dichloride trimethylphosphine, cyclopentadienylvanadium dichloride bis(trimethylphosphine), cyclopentadienylvanadium dichloride triethylphosphine, cyclopentadienylvanadium dichloride bis(triethylphosphine), cyclopentadienylvanadium dichloride(1,2-bisdimethylphosphinoethane), cyclopentadienylvanadium dichloride(1,2-bisdiphenylphosphinoethane), cyclopentadienylvanadium dichloride triphenylphosphine, pentadienylcyclopentadienylvanadium dichloride tetrahydrothiophene, cyclopentadienylvanadium dibromide tetrahydrofuran, cyclopentadienylvanadium diiodide tetrahydrofuran, methylcyclopentadienylvanadium dichloride tetrahydrofuran, methylcyclopentadienylvanadium dichloride trimethylphosphine, methylcyclopentadienylvanadium dichloride bis(trimethylphosphine), methylcyclopentadienylvanadium dichloride triethylphosphine and methylcyclopentadienylvanadium dichloride bis(triethylphosphine).

The catalyst system can be employed both for the homogeneous polymerization and for the heterogeneous polymerization of conjugated diolefins and/or copolymerization of conjugated diolefins with 1-olefins. In the case of heterogeneous polymerization, in addition, a supporting material is employed which is optionally pretreated.

Moreover, a process for the homopolymerization of conjugated dienes or for the copolymerization of conjugated dienes with one or more olefins in the presence of the catalyst system according to the present invention is part of the present invention.

This process is carried out under the conditions already described in this application with the monomers already described.

It can be advantageous to apply the cyclopentadienide compound and/or the catalysts system according to the present invention onto a support.

Preferably employed by way of supporting materials are particulate, organic or inorganic solids, the pore volume of which amounts to between 0.1 and 15 ml/g, preferably between 0.25 and 5 ml/g, the specific surface area of which is greater than 1, preferably 10 to 1,000 m²/g (BET), the particle size of which amounts to between 10 and 2,500 μm, preferably between 50 and 1,000 μm, and which may be modified on their surface in suitable manner.

The specific surface area is determined in conventional manner in accordance with DIN 66 131, the pore volume by the centrifugation method according to McDaniel, J. Colloid Interface Sci. 1980, 78, 31 and the particle size in accordance with Cornillaut, Appl. Opt. 1972, 11, 265.

By way of suitable inorganic solids, the following may be mentioned, for example: silica gels, precipitation silicic acids, clays, alumosilicates, talc, zeolites, carbon black, inorganic oxides such as, for example, silicon dioxide, aluminum oxide, magnesium oxide, titanium dioxide, inorganic chlorides such as, for example, magnesium chloride, sodium chloride, lithium chloride, calcium chloride, zinc chloride, or calcium carbonate.

The stated inorganic solids, which satisfy the specification stated above and are therefore particularly suitable for use as supporting materials, are described in greater detail in, for example, Ullmanns Enzyklopadie der technischen Chemie, Volume 21, p 439 ff (Silica gels), Volume 23, p 311 ff (Clays), Volume 14, p 633 ff (Carbon blacks) and Volume 24, p 575 ff (Zeolites).

Suitable by way of organic solids are pulverulent, polymeric materials, preferably in the form of free-flowing powders, having the properties stated above. In exemplary manner, mention may be made, without wishing to restrict the present invention, of: polyolefins such as, for example, polyethylene, polypropene, polystyrene, polystyrene-co-divinylbenzene, polybutadiene, polyethers such as, for example, polyethylene oxide, polyoxytetramethylene or polysulfides such as, for example, poly-p-phenylenesulfide. Preferable materials are polypropylene, polystyrene or polystyrene-co-divinylbenzene.

The stated organic solids, which satisfy the specification stated above and are therefore particularly suitable for use as supporting materials, are described in greater detail in, for example, Ullmanns Enzyklopädie der technischen Chemie, Volume 19, p 195 ff (Polypropylene), and Volume 19, p 265 ff (Polystyrene).

Production of the supported catalyst system can be effected within a wide temperature range. In general, the temperature lies between the melting-point and the boiling-point of the inert solvent mixture. Ordinarily working takes place at temperatures from −50 to +200° C., preferably −20 to 150° C., in particularly preferred manner 20 to 130° C.

By reason of its outstanding stability in solution, the catalyst system according to the present invention can be employed particularly well in a continuous technical process in the solution process.

The invention will be elucidated in greater detail on the basis of the following Examples.

### EXAMPLES

### General Data

Production and handling of organometallic compounds took place subject to exclusion of air and moisture under argon atmosphere (Schlenk method). All the required solvents were dehydrated prior to use by being boiled for many hours over a suitable drying agent and by subsequent distillation under argon. The compounds were characterized by ¹H-NMR, ¹³C-NMR and ¹⁹F-NMR. Other purchasable adducts were employed without further purification.

The following substances were procured commercially:

Witco: diisobutylaluminum hydride (DIBAH), neodymium versatate (Nd(vers)₃), Rhone-Poulenc S.A.,F.; lanthanum versatate (La(vers)₃), Rhone-Poulenc S.A.,F; Vulkanox® BKF, Bayer AG, D; Butadien 1,3,99+, Aldrich Chemie, D;

Polymer characterization: IR spectroscopic determination of the polymer composition was effected in accordance with E. O. Schmalz, W. Kimmer, Z. anal. Chem., 1961 (181) 229.

### Example 1

Into a 0.3-I glass autoclave which is equipped with a magnetic stirrer, a temperature sensor and a septum for the dosing of monomer and catalyst there were charged 100 ml cyclohexane and 23.2 g butadiene. The catalyst components were added by syringes in the following sequence and quantity: 1.2 ml of a 1.0-molar solution of DIBAH in toluene (DIBAH=diisobutylaluminum hydride; Al(iso-C₄H₉)₂H), 0.15 ml of a 0.264-molar solution of Nd(vers)₃ in hexane (Nd(vers)₃=neodymium(III) versatate; Nd(O₂C₁₀H₁₉)₃) and 0.4 ml of a 0.1-molar solution of [C₆H₅N(CH₃)₂H][C₅(C₆F₅)₅] in toluene. The polymerization apparatus was adjusted to 60° C. by means of an external water bath. After 85 min the reaction was stopped by addition of 5 ml methanol with 200 mg Vulkanox® BKF, the polymer was precipitated out in methanol, isolated and dried for 20 h at 60° C. in a vacuum. 13.3 g of a polybutadiene were obtained having the following composition: 90 wt. % 1,4-cis units, 7 wt. % 1,4-trans units and 3 wt. % 1,2-vinyl units (IR spectroscopic determination).

### Example 2

Into a 0.3-I glass autoclave which is equipped with a magnetic stirrer, a temperature sensor and a septum for the dosing of monomer and catalyst there were charged 100 ml cyclohexane and 21.3 g butadiene. The catalyst components were added by syringes in the following sequence and quantity: 1.2 ml of a 1.0-molar solution of DIBAH in toluene (DIBAH=diisobutylaluminum hydride; Al(iso-C₄H₉)₂H), 0.15 ml of a 0.264-molar solution of Nd(vers)₃ in hexane (Nd(vers)₃=neodymium(III) versatate; Nd(O₂C₁₀H₁₉)₃) and 0.4 ml of a 0.1-molar solution of [(C₆H₅)₃C][C₅(C₆F₅)₅] in toluene. The polymerization apparatus was adjusted to 60° C. by means of an external water bath. After 85 min, the reaction was stopped by addition of 5 ml methanol with 200 mg Vulkanox® BKF, the polymer was precipitated out in methanol, isolated and dried for 20 h at 60° C. in a vacuum. 6.3 g of a polybutadiene were obtained having the following composition: 84 wt. % 1,4-cis units, 14 wt. % 1,4-trans units and 2 wt. % 1,2-vinyl units (IR spectroscopic determination).

### Example 3

Into a 0.3-I glass autoclave which is equipped with a magnetic stirrer, a temperature sensor and a septum for the dosing of monomer and catalyst there were charged 100 ml toluene and 20.6 g butadiene. The catalyst components were added by syringes in the following sequence and quantity: 1.6 ml of a 1.0-molar solution of DIBAH in toluene (DIBAH=diisobutylaluminum hydride; AI(iso-C₄H₉)₂H), 0.053 ml of a 0.75-molar solution of La(vers)₃ in hexane (La(vers)₃=lanthanum(III) versatate; La(O₂C₁₀H₁₉)₃) and 0.4 ml of a 0.1-molar solution of [C₆H₅N(CH₃)₂H][C₅(C₆F₅)₅] in toluene. The polymerization apparatus was adjusted to 60° C. by means of an external water bath. After 120 min, the reaction was stopped by addition of 5 ml methanol with 200 mg Vulkanox® BKF, the polymer was precipitated out in methanol, isolated and dried for 20 h at 60° C. in a vacuum. 12.3 g of a polybutadiene were obtained having the following composition: 91 wt. % 1,4-cis units, 8 wt. % 1,4-trans units and 1 wt. % 1 ,2-vinyl units (IR spectroscopic determination).

### Example 4

In a 100-ml Schlenk vessel there were mixed together 1.8 ml of a 1.0-molar solution of DIBAH in toluene (DIBAH=diisobutylaluminum hydride; Al(iso-C₄H₉)₂H), 0.23 ml of a 0.264-molar solution of Nd(vers)₃ in hexane (Nd(vers)₃=neodymium(III) versatate; Nd(O₂C₁₀H₁₉)₃), 0.6 ml of a 0.1-molar solution of C₅(CH₃)₅H in cyclohexane, 0.6 ml of a 0.1-molar solution of isoprene in cyclohexane and 0.5 ml of a 0.1-molar solution of [C₆H₅N(CH₃)₂H][C₅(C₆F₅)₅] in methylene chloride and the solution was heated for one hour to 60° C. After cooling to room temperature, the catalyst solution was employed for the polymerization experiments without further treatment.

### Example 5

Into a 0.3-I glass autoclave which is equipped with a magnetic stirrer, a temperature sensor and a septum for the dosing of monomer and catalyst there were charged 100 ml cyclohexane and 23.2 g butadiene. 3.1 g of the catalyst solution from Example 4 were added with a syringe. The polymerization apparatus was adjusted to 60° C. by means of an external water bath. After 120 min, the reaction was stopped by addition of 5 ml methanol with 200 mg Vulkanox® BKF, the polymer was precipitated out in methanol, isolated and dried for 20 h at 60° C. in a vacuum. 1.4 g of a polybutadiene were obtained having the following composition: 74 wt. % 1,4-cis units, 7 wt. % 1,4-trans units and 19 wt. % 1,2-vinyl units (IR spectroscopic determination).

Although the invention has been described in detail in the foregoing for the purpose of illustration, it is to be understood that such detail is soley for that purpose and that variations can be made therein by those skilled in the art without departing from the spirit and scope of the invention except as it may be limited by the claims.

What is claimed is:

1. A process for the polymerization of dienes, comprising the step of polymerizing the dienes in the presence of a metal-free and metalloid-free cyclopentadienide compound of the general formula (II) 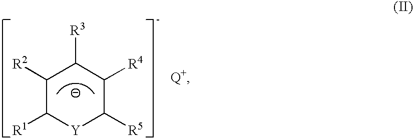
wherein
Q⁺ signifies a Lewis-acid cation according to the Lewis acid/base theory, or a Brønstedt-acid cation according to the Brønstedt acid/base theory,
Y represents a (CR₂⁶)ₘ group with m=0 to 4, whereby the residues R⁶ may be the same or different, whereby if m=0, the ring may be closed or open, with the proviso that if the ring is open, the free valences on the terminal C atoms are saturated by residues R which have the same significance as R¹-R⁶,
R¹-R⁶ represent identical or different substituents selected from the group consisting of hydrogen, phenyl, aryl, C₁-C₂₀ alkyl, C₁-C₁₀ haloalkane, C₆-C₁₀ haloaryl, C₁- C₁₀ alkoxy, C₆-C₂₀ aryl, C₆-C₁₀ aryloxy, C₂-C₁₀ alkenyl, C₇-C₄₀ arylalkenyl, C₂-C₁₀ alkynyl, silyl optionally substituted by C₁- C₁₀ hydrocarbon residues, amine substituted C₁-C₂₀ hydrocarbon residues,
with the proviso that at least one substituent is bulky.

2. A process for the polymerization of dienes according to claim 1, wherein at least two substituents are bulky.

3. A process for the polymerization of dienes according to claim 2, wherein at least three substituents are bulky.

4. A process for the polymerization of dienes according to claim 1, wherein at least one R from R¹-R⁶ represents a halogen-containing aromatic compound of the formula III 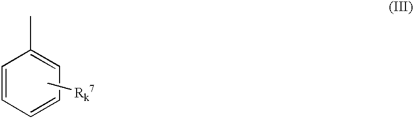
wherein
k represents an integer in the range from 1 to 5 and
R⁷ is selected from the group consisting of C₁-C₂₀ alkyl, C₁-C₂₀ alkoxy, hydrogen, halogen and C₁-C₂₅ haloalkane, with the proviso that at least one R⁷ represents halogen or C₁-C₂₅ haloalkane.

5. A process for the polymerization of dienes according to claim 4, wherein at least one R from R¹-R⁶ is selected from the group consisting of 4-fluorophenyl, 4-chlorophenyl, 3-fluorophenyl, 3-chlorophenyl, 2-fluorophenyl, 2-chlorophenyl, 2,6-difluorophenyl, 2,6-dichlorophenyl, 2,4-difluorophenyl, 2,4-dichlorophenyl, 2,3-difluorophenyl, 2,3-dichlorophenyl, 2,5-difluorophenyl, 2,5-dichlorophenyl, 3,4-difluorophenyl, 3,4-dichlorophenyl, 3,5-difluorophenyl, 3,5-dichlorophenyl, 2,4,6-trifluorophenyl, 3,4,5-trifluorophenyl;, 2,3,4-trifluorophenyl, 2,3,5-trifluorophenyl, 2,3,6-trifluorophenyl, 2,3,4,5-tetrafluorophenyl, 2,3,5,6-tetrafluorophenyl, 4,5,6-tetrafluorophenyl, pentafluorophenyl, 4-(trifluoromethyl)phenyl, 2,6-bis(trifluoromethyl)phenyl, 3,5-bis(trifluoromethyl)phenyl, 3,4,5-tris(trifluoromethyl)phenyl, and 2,4,4-tris(trifluoromethyl)phenyl and compounds corresponding to the compounds just named, in which one or more fluorine atoms have been replaced by chlorine atoms.

6. A process for the polymerization of dienes according to claim 5, wherein at least one R from R¹-R⁶ is selected from the group consisting of 4-fluorophenyl, 2,6-difluorophenyl, 2,4-difluorophenyl, 2,4,6-trifluorophenyl, pentafluorophenyl, 3,5-bis(trifluoromethyl)phenyl and compounds corresponding to the compounds just named, in which one or more fluorine atoms have been replaced by chlorine atoms.

7. A process for the polymerization of dienes according to claim 1, wherein by way of metal-free and metalloid-free cyclopentadienide compound a compound of the general formula (IIc) is employed 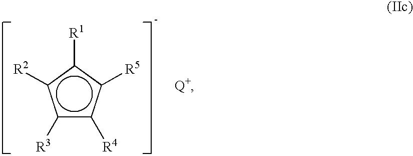
wherein
Q⁺ represents a Lewis-acid cation according to the Lewis acid/base theory, wherein said Lewis-acid cation is selected from the group consisting of preferably carbonium, oxonium or/and sulfonium cations, or a Brønstedt-acid cation according to the Brønstedt acid/base theory,
R¹-R⁵ represent identical or different substituents selected from the group consisting of hydrogen, phenyl, aryl, C₁-C₂₀ alkyl, C₁-C₁₀ haloalkane, C₆-C₁₀ haloaryl, C₁-C₁₀ alkoxy, C₆-C₂₀ aryl, C₆-C₁₀ aryloxy, C₂-C₁₀ alkenyl, C₇- C₄₀ arylalkenyl, C₂-C₁₀ alkynyl, silyl optionally substituted by C₁- C₂₀ hydrocarbon residues, amine substituted C₁-C₂₀ hydrocarbon residues,
with the proviso that at least one substituent is bulky.

8. A process for the polymerization of dienes according to claim 7, wherein at least two substituents are bulky.

9. A process for the polymerization of dienes according to claim 8, wherein at least three substituents are bulky.

10. A composition comprising at least one metal-free and metalloid-free cyclopentadienide compound of the general formula (II) 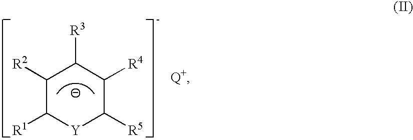
wherein
Q⁺ signifies a Lewis-acid cation according to the Lewis acid/base theory or a Brønstedt-acid cation according to the Brønstedt acid/base theory,
Y represents a (CR₂⁶)ₘ group with m=0 to 4, whereby the residues R⁶ may be the same or different, whereby if m=0 the ring may be closed or open, with the proviso that if the ring is open the free valences on the terminal C atoms are saturated by residues R which have the same significance as R¹-R⁶,
R¹-R⁶ represent identical or different substituents selected from the group consisting of hydrogen, phenyl, aryl, C₁-C₂₀ alkyl, C₁-C₁₀ haloalkane, C₆- C₁₀ haloaryl, C₁-C₁₀ alkoxy, C₆-C₂₀ aryl, C₆-C₁₀ aryloxy, C₂-C₁₀ alkenyl, C₇-C₄₀ arylalkenyl, C₂-C₁₀ alkynyl, silyl optionally substituted by C₁-C₁₀ hydrocarbon residues, amine substituted C₁-C₂₀ hydrocarbon residues,
with the proviso that at least one substituent is bulky and also at least one transition-metal compound and also, optionally in addition, an organoaluminum compound.

11. A composition according to claim 10, wherein at least two substituents are bulky.

12. A composition according to claim 11, wherein at least three substituents are bulky.

13. A composition according to claim 10, wherein the transition-metal compounds are selected from the group of compounds consisting of the rare-earth metals, monocyclopentadienyl compounds of titanium, monocyclopentadienyl compounds of vanadium and mixtures of these.

14. A composition according to claim 13, wherein the compounds of the rare-earth metals are selected from the group consisting of alcoholate of the rare-earth metals, carboxylate of the rare-earth metals, complex compound of the rare-earth metals with diketones and an addition compound of the halides of the rare-earth metals with an oxygen or nitrogen donor compound.

15. A process for the homopolymerization of conjugated dienes or for the copolymerization of conjugated dienes with one or more olefins, comprising the step of polymerizing in the presence of a composition comprising at least one metal-free and metalloid-free cyclopentadienide compound of the general formula (II) R 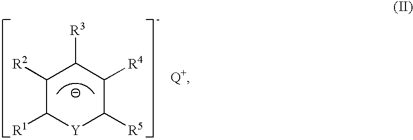
wherein
Q⁺ signifies a Lewis-acid cation according to the Lewis acid/base theory or a Brønstedt-acid cation according to the Brønstedt acid/base theory,
Y represents a (CR₂⁶)ₘ group with m=0 to 4, whereby the residues R⁶ may be the same or different, whereby if m=0 the ring may be closed or open, with the proviso that if the ring is open the free valences on the terminal C atoms are saturated by residues R which have the same significance as R¹-R⁶,
R¹-R⁶ represent identical or different substituents selected from the group consisting of hydrogen, phenyl, aryl, C₁-C₂₀ alkyl, C₁-C₁₀ haloalkane, C₆-C₁₀ haloaryl, C₁-C₁₀ alkoxy, C₆-C₂₀ aryl, C₆-C₁₀ aryloxy, C₂-C₁₀ alkenyl, C₇- C₄₀ arylalkenyl, C₂-C₁₀ alkynyl, silyl optionally substituted by C₁-C₁₀ hydrocarbon residues, amine substituted C₁-C₂₀ hydrocarbon residues,
with the proviso that at least one substituent is bulky and also at least one transition-metal compound and also, optionally in addition, an organoaluminum compound.

16. A catalyst containing a composition comprising at least one metal-free and metalloid-free cyclopentadienide compound of the general formula (II) 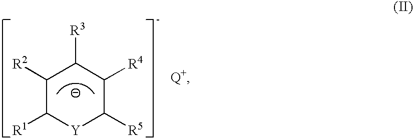
wherein
Q⁺ represents a Lewis-acid cation according to the Lewis acid/base theory or a Brønstedt-acid cation according to the Brønstedt acid/base theory,
Y represents a (CR₂⁶)ₘ group with m=0 to 4, whereby the residues R⁶ may be the same or different, whereby if m=0 the ring may be closed or open, with the proviso that if the ring is open the free valences on the terminal C atoms are saturated by residues R which have the same significance as R¹-R⁶,
R¹-R⁶ represent identical or different substituents selected from the group consisting of hydrogen, phenyl, aryl, C₁- C₂₀ alkyl, C₁-C₁₀ haloalkane, C₆-C₁₀ haloaryl, C₁-C₁₀ alkoxy, C₆-C₂₀ aryl, C₆-C₁₀ aryloxy, C₂-C₁₀ alkenyl, C₇-C₄₀ arylalkenyl, C₂-C₁₀ alkynyl, silyl optionally substituted by C₁- C₁₀ hydrocarbon residues, amine substituted C₁- C₂₀ hydrocarbon residues,
with the proviso that at least one substituent is bulky and also at least one transition-metal compound and also, optionally in addition, an organoaluminum compound.
